(19) United States
(12) Patent Application Publication
(10) Pub. No.: US 2023/0381639 A1
(43) Pub. Date: Nov. 30, 2023

(54) COMPATIBLE ACCESSORY MODULE

(71) Applicant: Meta Platforms Technologies, LLC, Menlo Park, CA (US)

(72) Inventors: Dawn Wilken, San Carlos, CA (US); Riley Hageman, Seattle, WA (US); Igor Kozintsev, San Jose, CA (US)

(21) Appl. No.: 17/752,724

(22) Filed: May 24, 2022

(51) Int. Cl. A63F 13/285; A63F 13/24; G06F 3/01

(52) U.S. Cl. CPC A63F 13/285; A63F 13/24; G06F 3/016; G06F 3/014; A63F 2300/8082; A63F 2300/8011; A63F 2300/8035

(57) ABSTRACT

Embodiments of the present disclosure may include a universally compatible accessory module, including a haptics driver. Embodiments may also include a light emitting diode (LED) driver. Embodiments may also include a battery. Embodiments may also include a plurality of LEDs controlled by the LED driver, the plurality of LEDs located along external edges of the module according to a unique geometry. Embodiments may also include at least one mechanical actuator controlled by the haptics driver.

### TECHNICAL FIELD

The present disclosure generally relates to haptic feedback in peripheral accessories, and more particularly to a universally compatible accessory module.

### BACKGROUND

Video and computer games began as simple two-dimensional games a user would view on a monitor during game play but have evolved to more complex 3D and even virtual reality games. Even these games can quickly become routine and boring without something more to stimulate the gamer.

Today's virtual reality games (e.g., sports games) necessitate the development of accessories that enhance the user experience and game performance. Examples of generic sport accessories include, but are not limited to, table tennis paddles, tennis rackets, fishing poles, and lightsabers that can be used as game controllers for corresponding virtual reality games.

Existing game controllers can be mechanically mounted to these generic sport accessories. But “hacking” a game controller to a generic sport accessory generally does not have the same shape or balance to provide the same feel of the actual activity during game play.

### BRIEF SUMMARY

The subject disclosure provides for a universally compatible accessory module. A user is allowed to engage in virtual reality games with game accessories that enhance the user experience and game performance by mimicking the shape, balance, and overall feel of the actual accessories to provide the same feel of the actual activity during game play. For example, a universally compatible accessory module may be interchangeable with a variety of different form factors (e.g., a tennis racket, a table tennis paddle, and a fishing pole) that closely mimic the feel and experience of the activity with closely corresponding shape, weight, and accurate haptics of actual accessories.

One aspect of the disclosure relates to a universally compatible accessory module, including a haptics driver. Embodiments may also include a light emitting diode (LED) driver. Embodiments may also include a battery. Embodiments may also include a plurality of LEDs controlled by the LED driver. The plurality of LEDs may be located along external edges of the module according to a unique geometry. Embodiments may also include at least one mechanical actuator controlled by the haptics driver.

Another aspect of the disclosure relates to a universally compatible accessory module, including a haptics driver. Embodiments may also include a light emitting diode (LED) driver. Embodiments may also include a battery. Embodiments may also include a plurality of LEDs controlled by the LED driver. The plurality of LEDs may be located along external edges of the module according to a unique geometry. Embodiments may also include at least one mechanical actuator controlled by the haptics driver. Embodiments may also include the haptics driver and the LED driver interchangeably coupled with a variety of different accessories including at least one of sports accessories, inclusive controller, and/or gloves.

Yet another aspect of the disclosure relates to a universally compatible accessory module, including a haptics driver. Embodiments may also include a light emitting diode (LED) driver. Embodiments may also include a battery. Embodiments may also include a plurality of LEDs controlled by the LED driver. The plurality of LEDs may be located along external edges of the module according to a unique geometry. Embodiments may also include at least one mechanical actuator controlled by the haptics driver. Embodiments may also include an offboard portion having the plurality of LEDs and an onboard portion having control electronics including at least the haptics driver and the LED driver. Embodiments may also include the onboard portion interchangeably coupled with a variety of different accessories uniquely identified by a constellation of at least some of the plurality of LEDs. The different accessories may include at least one of sports accessories, inclusive controller, and/or gloves.

Still another aspect of the disclosure relates to a universally compatible accessory module, including a means for driving haptics. Embodiments may also include a means for driving a light source. Embodiments may also include a means for providing power. Embodiments may also include a plurality of means for emitting light by the means for driving a light source, the plurality of means for emitting light located along external edges of the module according to a unique geometry. Embodiments may also include at least one means for actuating controlled by the means for driving haptics.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a high-level block diagram illustrating onboard and offboard components of an example universally compatible accessory module, in accordance with one or more embodiments.

FIG. 2 are perspective views of example table tennis paddle and tennis racket sports accessories which may implement the example universally compatible accessory module, in accordance with one or more embodiments.

FIG. 3 are perspective views of example fishing pole sports accessories which may implement the example universally compatible accessory module, in accordance with one or more embodiments.

FIG. 4 illustrates a universally compatible accessory module, in accordance with one or more implementations.

FIG. 5 is a block diagram illustrating an example computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

Currently, game controllers for virtual reality games are generically manufactured for different games. The game controllers may be mechanically mounted to generic accessories for use with different types of games (e.g., a steering wheel for a driving game). However, the game controller mounted as such typically does not have the correct shape, weight, and haptics and therefore does not closely mimic the feel and experience of the actual activity.

The subject disclosure provides for a universally compatible accessory module. The universally compatible accessory module includes game accessories that enhance the user experience and game performance by mimicking the shape, balance, and overall feel of the actual accessories to provide a gaming experience that is very similar to that of the actual activity. For example, a universally compatible accessory module may be interchangeable with a variety of different form factors (e.g., a tennis racket, a table tennis paddle, and a fishing pole) that closely mimic the feel and experience of the activity with closely corresponding shape, weight, and accurate haptics of actual accessories.

Implementations described herein address the aforementioned shortcomings and other shortcomings by providing a universally compatible accessory module that can be used with a number of different form factors (e.g., a tennis racket, a table tennis paddle, and a fishing pole). The accessory module closely mimics the feel and experience of the activity with shape, weight, and accurate haptics. In an example, a family of accessories can be provided with interchangeable control electronics that can identify the specific form factor with custom constellations, and match haptic feedback for the activity. In an example, the accessory module can also be used with already existing games.

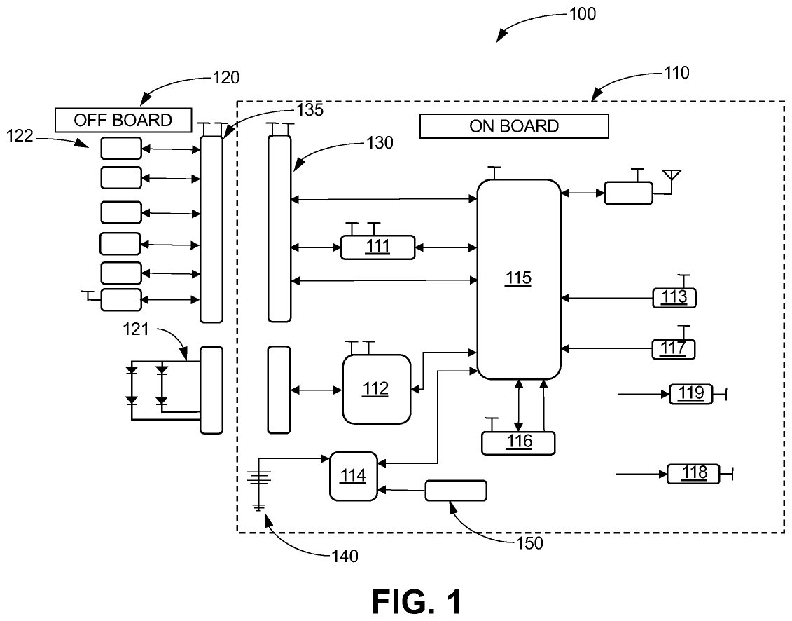

FIG. 1 is a high-level block diagram illustrating onboard portion 110 and offboard portion 120 components of an example universally compatible accessory module 100, in accordance with one or more embodiments. In an example, control electronics are provided on the onboard portion 110. For example, the haptics driver 111 and the light emitting diode (LED) driver 112 are provided on the onboard portion 110. LEDs 121 are provided on the offboard portion 120, along with user controls 122 such as button(s), triggers, thumbwheel(s), home button, etc., similar to a conventional gaming controller. At a minimum, the offboard portion 120 includes a button, a trigger (may be binary), and an analogue input. One or more mechanical actuators may also be provided on the offboard portion.

Control electronics of the onboard portion 110 may include one or more processor 115, a haptic driver 111, infrared LED 113 (e.g., for status), a charging unit 114 (e.g., for charging the battery), an inertial measurement unit (IMU) 116, home button 117, and a load switch 118. Still further examples of control electronics may include, but are not limited to, LED boost and LED driver 112 (e.g., powered by an on-board battery 140). A buck converter 119 may be provided to remove the need for boost integrated circuits. A USB type connector 150 may be provided for electrical power input (e.g., for battery charging).

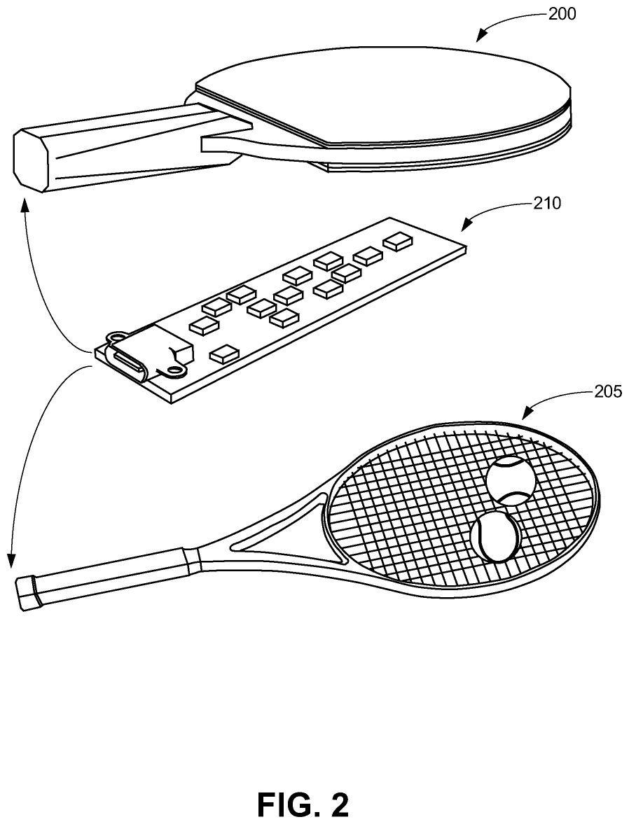

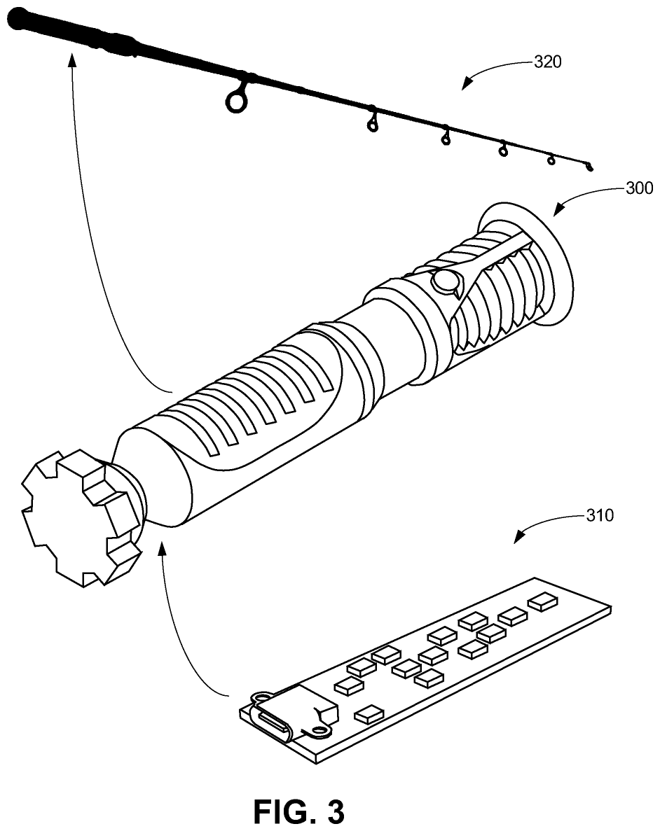

The onboard portion 110 is linked to the offboard portion 120 by physical and/or by wireless connectors 130, 135. Such a configuration enables the onboard portion 110 of the accessory module 100 to be interchanged with different form factors housing the offboard portion 120, while the offboard portion 120 is unique to the form factor. By way of illustration, the onboard portion 110 of the module 100 may include an electronics platform, such as one or more circuit boards or PCB with control electronics for controlling a variety of different form factors (see, e.g., FIGS. 2 and 3). In an example, the control electronics of the onboard portion 110 are implemented at least in part on a printed circuit board (PCB). The LEDs 121 may be provided for each form factor and may be unique for each form factor. This enables the LEDs 121 to identify a type of the different accessories or form factor to the control electronics.

In an example, the control electronics adapt for each of the different accessories or form factors according to a constellation, e.g., by constellation tracking. By way of illustration, the LEDs 121 may identify the type of form factor for the control electronics by the specific constellation. The LEDs 121 may identify the left and right side of the same type of separate accessories by the constellation. The LEDs may identify the orientation of the different accessories by the constellation. In an example, the control electronics of the onboard portion 120 adapt for each of the different accessories according to size, shape, haptics, and weight.

In an example, the constellation is defined by the LED geometry on the form factor. By way of illustration, six (6) LEDs may be positioned on the edge of the form factor (e.g., along a handle of a tennis racket). The LED placement may be at a uniform distance from each other, and then the locations of the LEDs may be “perturbed,” e.g., changed by about 1 cm, to destroy the symmetry and create a unique constellation for each specific form factor. That is, each form factor has a unique constellation thereby identifying the form factor (e.g., as either a table tennis paddle or a tennis racket).

In an example, the onboard portion 110 may also execute firmware and/or software. Example execution may include pairing the controller to the gaming device, issuing commands and/or feedback according to the constellation, or controlling haptics (e.g., specific to the form factor). In an example, the software and/or firmware supports writing a custom LED/IMU calibration file and FW update over a debug interface. In an example, a tracking service may support custom LED/IMU geometry. The software and/or firmware may support the re-use of current games that allow for modified controllers.

FIG. 2 are perspective views of example table tennis paddle 200 and tennis racket 205 sports accessories which may implement the example universally compatible accessory module 210, in accordance with one or more embodiments. In an example, the overall shape of the form factor closely mimics the actual device (e.g., an actual table tennis paddle, an actual tennis racket, etc.). It is noted that the example table tennis paddle 200 and tennis racket 205 shown in FIG. 2 represent the offboard portion of the module which mimic the actual device but are not actual devices having a game controller strapped to the device. Instead, the example table tennis paddle 200 and tennis racket 205 sports accessories are specially configured as part of the overall module for use with the onboard portion of the module 210.

All electronics are provided on the onboard portion of the module 210 (e.g., the PCB shown in FIG. 2), and are thus “built-in” when the onboard portion of the module 210 is added to the form factor (e.g., inserted into the handle of the table tennis paddle 200 or the tennis racket 205). As such, a conventional game controller need not be strapped onto the device for game play. In addition, the onboard portion of the module 210 can be interchanged between different form factors (e.g., between the table tennis paddle 200 and the tennis racket 205 sports accessories shown in FIG. 2), so that only one of the onboard portions of the module 210 having the control electronics need to be provided for a variety of different form factors. Haptics specific to the form factor (e.g., specific to the table tennis paddle 200 and specific to the tennis racket 205) are provided unique to each form factor, and adaptively controlled through mechanical actuators (e.g., magnetic and/or piezo) of the onboard control electronics of the table tennis paddle 200 or the tennis racket 205.

FIG. 3 are perspective views of an example fishing pole sports accessory 300 which may implement the example universally compatible accessory module 310, in accordance with one or more embodiments. In an example, the overall shape of the form factor (e.g., fishing pole sports accessory 300 in FIG. 3) closely mimics the actual device (e.g., a fishing pole 320 illustrated at the top of FIG. 3). Again, all electronics are provided on the onboard portion of the module 310 (e.g., the PCB shown in FIG. 3), and are thus “built-in” when the onboard portion of the module 310 is added to the form factor (e.g., inserted into the fishing pole handle 300) and a conventional game controller need not be strapped onto a fishing pole device 320 for game play. In addition, the onboard portion of the module 310 can be interchanged between different form factors (e.g., between the fishing pole handle 300 in FIG. 3 and either or both of the table tennis paddle 200 or the tennis racket 205 shown in FIG. 2). Only one of the onboard portion of the module 310 having the control electronics needs to be provided for a variety of different form factors. Haptics specific to the form factor (e.g., the fishing pole handle 300 in FIG. 3) may be provided uniquely to each form factor, and adaptively controlled through mechanical actuators (e.g., magnetic and/or piezo) of the onboard control electronics.

The disclosed system(s) address a problem in traditional haptic feedback techniques tied to computer technology, namely, the technical problem of providing the user with a gaming experience that closely mimics the feel of the actual activity. The disclosed system solves this technical problem by providing a solution also rooted in computer technology, namely, by providing for a universally compatible accessory module. The disclosed subject technology further provides improvements to the functioning of the computer itself because it improves processing and efficiency in providing haptic feedback.

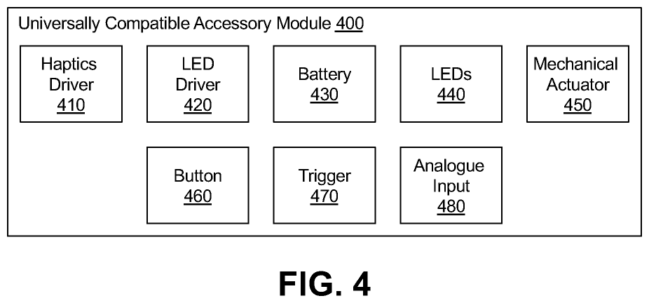

FIG. 4 is a block diagram that shows a universally compatible accessory module 400, according to another embodiment of the present disclosure. In some embodiments, the universally compatible accessory module 400 may include a haptics driver 410, a light emitting diode (LED) driver 420, a battery 430, a plurality of LEDs 440 controlled by the LED driver 420, at least one mechanical actuator 450 controlled by the haptics driver 410, at least one button 460, at least one trigger 470, and at least one analogue input 480. The plurality of LEDs 440 may be located along external edges of the module 400 according to a unique geometry.

Haptics driver 410 may be any suitable driver that provides drive capability (e.g., 1 kHz) to cover a broad range of sensitivity to human touch. The haptics driver 410 is provided on the onboard portion to drive the haptic actuator(s) and motor(s) on the offboard portion to provide realistic haptic experiences for the user.

LED driver 420 may be any suitable driver that regulates power to an LED or plurality of LEDs 440. The LED driver 420 may be a constant current LED driver and/or a constant voltage LED driver, to provide fixed power output to the LEDs 440. Any suitable LEDs 440 may be provided. In an example, the same and/or separate LEDs 440 may be provided for the constellation, status, and/or other user feedback.

Any suitable mechanical actuator 450 may be provided. In an example, the mechanical actuator 450 provides variable-frequency, variable amplitude, and/or mechanical vibrations for the gaming controller.

The button 460, at least one trigger 470, and at least one analogue input 480 may be provided as conventional input/output devices for gaming controllers and/or may be specially configured for use with the offboard portion of the module. For example, specially configured buttons, triggers, and analogue inputs may be provided specific for the type of form factor (e.g., a tennis racket or fishing pole handle).

In some embodiments, the mechanical actuators 450 may be at least one of magnetic and piezo. In some embodiments, the unique geometry may comprise spacing the LEDs 440 at a uniform distance apart and then perturbing the spacing by about 1 cm. In some embodiments, the unique geometry may be asymmetric. In some embodiments, there may be six LEDs 440. In some embodiments, the module 400 may come in a pair, the pair comprising one module for each hand.

Magnetic actuators operate on the principle of Lorentz forces. That is, a current-carrying conductor is placed in a static magnetic field to produce a field around the conductor that interacts with the static field and produces a force. Piezo actuators operate by converting an electrical signal into a physical displacement. In either case (magnetic and piezo), the force can cause displacement of a mechanical structure, such as is present in the form factor of the gaming device.

In some embodiments, the module 400 may be implemented as an onboard portion and an offboard portion. Control electronics may be provided on the onboard portion and the LEDs may be provided on the offboard portion. In some embodiments, the haptics driver 410 and the light emitting diode (LED) driver 420 may be provided on the onboard portion. In some embodiments, the at least one mechanical actuator 450 may be provided on the offboard portion. In some embodiments, the onboard portion may be linked to the offboard portion by wireless connectors. In some embodiments, the control electronics of the onboard portion may be implemented at least in part on a printed circuit board (PCB).

In some embodiments, the onboard portion may be interchangeably coupled with a variety of different accessories. Any of a wide variety of different accessories (or “form factors” as referred to herein) may be implemented. Examples include the table tennis paddle and tennis racket shown in FIG. 2 and the fishing pole handle shown in FIG. 3. However, other form factors may also be provided, both form factors that are already known and those that may be developed in the future.

In some embodiments, a type of the different accessories may be identified by a constellation. The term “constellation” as it is used herein refers to a group of lights (e.g., formed by output from one or more of the LEDs) that form a recognizable pattern, group, or cluster. The constellation may be a based at least in part on the physical position of the LEDs on the form factor and/or on operation of the LEDs (e.g., timing the lighting and/or light output of the LEDs). In some embodiments, the left and right side of the same type of separate accessories may be identified by the constellation. In some embodiments, orientation of the different accessories may be identified by the constellation.

In some embodiments, the control electronics may adapt for each of the different accessories according to the constellation. By adapting, the control electronics may implement different input/output scenarios specific to the form factor and/or game that is being played (e.g., by executing firmware, software, and/or various routines embodied in program code). In some embodiments, the control electronics may adapt for each of the different accessories according to size, shape, haptics, and weight. In some embodiments, the sports accessories may include at least one of sports accessories, inclusive controller, and/or gloves. In some embodiments, the sports accessories may include at least one of a tennis racket, table tennis paddle, lightsaber, beatsaber, and fishing pole.

In particular embodiments, one or more objects (e.g., content or other types of objects) of a computing system may be associated with one or more privacy settings. The one or more objects may be stored on or otherwise associated with any suitable computing system or application, such as, for example, a social-networking system, a client system, a third-party system, a social-networking application, a messaging application, a photo-sharing application, or any other suitable computing system or application. Although the examples discussed herein are in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular embodiments, privacy settings for an object may specify a “blocked list” of users or other entities that should not be allowed to access certain information associated with the object. In particular embodiments, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular embodiments, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular concept node corresponding to a particular photo may have a privacy setting specifying that the photo may be accessed only by users tagged in the photo and friends of the users tagged in the photo. In particular embodiments, privacy settings may allow users to opt in to or opt out of having their content, information, or actions stored/logged by the social-networking system or shared with other systems (e.g., a third-party system). Although this disclosure describes using particular privacy settings in a particular manner, this disclosure contemplates using any suitable privacy settings in any suitable manner.

In particular embodiments, privacy settings may be based on one or more nodes or edges of a social graph. A privacy setting may be specified for one or more edges or edge-types of the social graph, or with respect to one or more nodes, or node-types of the social graph. The privacy settings applied to a particular edge connecting two nodes may control whether the relationship between the two entities corresponding to the nodes is visible to other users of the online social network. Similarly, the privacy settings applied to a particular node may control whether the user or concept corresponding to the node is visible to other users of the online social network. As an example and not by way of limitation, a first user may share an object to the social-networking system. The object may be associated with a concept node connected to a user node of the first user by an edge. The first user may specify privacy settings that apply to a particular edge connecting to the concept node of the object, or may specify privacy settings that apply to all edges connecting to the concept node. As another example and not by way of limitation, the first user may share a set of objects of a particular object-type (e.g., a set of images). The first user may specify privacy settings with respect to all objects associated with the first user of that particular object-type as having a particular privacy setting (e.g., specifying that all images posted by the first user are visible only to friends of the first user and/or users tagged in the images).

In particular embodiments, the social-networking system may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular embodiments, the social-networking system may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of a particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular embodiments, one or more servers may be authorization/privacy servers for enforcing privacy settings. In response to a request from a user (or other entity) for a particular object stored in a data store, the social-networking system may send a request to the data store for the object. The request may identify the user associated with the request and the object may be sent only to the user (or a client system of the user) if the authorization server determines that the user is authorized to access the object based on the privacy settings associated with the object. If the requesting user is not authorized to access the object, the authorization server may prevent the requested object from being retrieved from the data store or may prevent the requested object from being sent to the user. In the search-query context, an object may be provided as a search result only if the querying user is authorized to access the object, e.g., if the privacy settings for the object allow it to be surfaced to, discovered by, or otherwise visible to the querying user. In particular embodiments, an object may represent content that is visible to a user through a newsfeed of the user. As an example and not by way of limitation, one or more objects may be visible to a user's “Trending” page. In particular embodiments, an object may correspond to a particular user. The object may be content associated with the particular user, or may be the particular user's account or information stored on the social-networking system, or other computing system. As an example and not by way of limitation, a first user may view one or more second users of an online social network through a “People You May Know” function of the online social network, or by viewing a list of friends of the first user. As an example and not by way of limitation, a first user may specify that they do not wish to see objects associated with a particular second user in their newsfeed or friends list. If the privacy settings for the object do not allow it to be surfaced to, discovered by, or visible to the user, the object may be excluded from the search results. Although this disclosure describes enforcing privacy settings in a particular manner, this disclosure contemplates enforcing privacy settings in any suitable manner.

In particular embodiments, different objects of the same type associated with a user may have different privacy settings. Different types of objects associated with a user may have different types of privacy settings. As an example and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. In particular embodiments, different privacy settings may be provided for different user groups or user demographics. As an example and not by way of limitation, a first user may specify that other users who attend the same university as the first user may view the first user's pictures, but that other users who are family members of the first user may not view those same pictures.

In particular embodiments, the social-networking system may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In particular embodiments, privacy settings may allow a first user to specify (e.g., by opting out, by not opting in) whether the social-networking system may receive, collect, log, or store particular objects or information associated with the user for any purpose. In particular embodiments, privacy settings may allow the first user to specify whether particular applications or processes may access, store, or use particular objects or information associated with the user. The privacy settings may allow the first user to opt in or opt out of having objects or information accessed, stored, or used by specific applications or processes. The social-networking system may access such information in order to provide a particular function or service to the first user, without the social-networking system having access to that information for any other purposes. Before accessing, storing, or using such objects or information, the social-networking system may prompt the user to provide privacy settings specifying which applications or processes, if any, may access, store, or use the object or information prior to allowing any such action. As an example and not by way of limitation, a first user may transmit a message to a second user via an application related to the online social network (e.g., a messaging app), and may specify privacy settings that such messages should not be stored by the social-networking system.

In particular embodiments, a user may specify whether particular types of objects or information associated with the first user may be accessed, stored, or used by the social-networking system. As an example and not by way of limitation, the first user may specify that images sent by the first user through the social-networking system may not be stored by the social-networking system. As another example and not by way of limitation, a first user may specify that messages sent from the first user to a particular second user may not be stored by the social-networking system. As yet another example and not by way of limitation, a first user may specify that all objects sent via a particular application may be saved by the social-networking system.

In particular embodiments, privacy settings may allow a first user to specify whether particular objects or information associated with the first user may be accessed from particular client systems or third-party systems. The privacy settings may allow the first user to opt in or opt out of having objects or information accessed from a particular device (e.g., the phone book on a user's smart phone), from a particular application (e.g., a messaging app), or from a particular system (e.g., an email server). The social-networking system may provide default privacy settings with respect to each device, system, or application, and/or the first user may be prompted to specify a particular privacy setting for each context. As an example and not by way of limitation, the first user may utilize a location-services feature of the social-networking system to provide recommendations for restaurants or other places in proximity to the user. The first user's default privacy settings may specify that the social-networking system may use location information provided from a client device of the first user to provide the location-based services, but that the social-networking system may not store the location information of the first user or provide it to any third-party system. The first user may then update the privacy settings to allow location information to be used by a third-party image-sharing application in order to geo-tag photos.

In particular embodiments, privacy settings may allow a user to specify one or more geographic locations from which objects can be accessed. Access or denial of access to the objects may depend on the geographic location of a user who is attempting to access the objects. As an example and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

In particular embodiments, changes to privacy settings may take effect retroactively, affecting the visibility of objects and content shared prior to the change. As an example and not by way of limitation, a first user may share a first image and specify that the first image is to be public to all other users. At a later time, the first user may specify that any images shared by the first user should be made visible only to a first user group. The social-networking system may determine that this privacy setting also applies to the first image and make the first image visible only to the first user group. In particular embodiments, the change in privacy settings may take effect only going forward. Continuing the example above, if the first user changes privacy settings and then shares a second image, the second image may be visible only to the first user group, but the first image may remain visible to all users. In particular embodiments, in response to a user action to change a privacy setting, the social-networking system may further prompt the user to indicate whether the user wants to apply the changes to the privacy setting retroactively. In particular embodiments, a user change to privacy settings may be a one-off change specific to one object. In particular embodiments, a user change to privacy may be a global change for all objects associated with the user.

In particular embodiments, the social-networking system may determine that a first user may want to change one or more privacy settings in response to a trigger action associated with the first user. The trigger action may be any suitable action on the online social network. As an example and not by way of limitation, a trigger action may be a change in the relationship between a first and second user of the online social network (e.g., “un-friending” a user, changing the relationship status between the users). In particular embodiments, upon determining that a trigger action has occurred, the social-networking system may prompt the first user to change the privacy settings regarding the visibility of objects associated with the first user. The prompt may redirect the first user to a workflow process for editing privacy settings with respect to one or more entities associated with the trigger action. The privacy settings associated with the first user may be changed only in response to an explicit input from the first user, and may not be changed without the approval of the first user. As an example and not by way of limitation, the workflow process may include providing the first user with the current privacy settings with respect to the second user or to a group of users (e.g., un-tagging the first user or second user from particular objects, changing the visibility of particular objects with respect to the second user or group of users), and receiving an indication from the first user to change the privacy settings based on any of the methods described herein, or to keep the existing privacy settings.

In particular embodiments, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example and not by way of limitation, a user's default privacy settings may indicate that a person's relationship status is visible to all users (i.e., “public”). However, if the user changes his or her relationship status, the social-networking system may determine that such action may be sensitive and may prompt the user to confirm that his or her relationship status should remain public before proceeding. As another example and not by way of limitation, a user's privacy settings may specify that the user's posts are visible only to friends of the user. However, if the user changes the privacy setting for his or her posts to being public, the social-networking system may prompt the user with a reminder of the user's current privacy settings of posts being visible only to friends, and a warning that this change will make all of the user's past posts visible to the public. The user may then be required to provide a second verification, input authentication credentials, or provide other types of verification before proceeding with the change in privacy settings. In particular embodiments, a user may need to provide verification of a privacy setting on a periodic basis. A prompt or reminder may be periodically sent to the user based either on time elapsed or a number of user actions. As an example and not by way of limitation, the social-networking system may send a reminder to the user to confirm his or her privacy settings every six months or after every ten photo posts. In particular embodiments, privacy settings may also allow users to control access to the objects or information on a per-request basis. As an example and not by way of limitation, the social-networking system may notify the user whenever a third-party system attempts to access information associated with the user, and require the user to provide verification that access should be allowed before proceeding.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

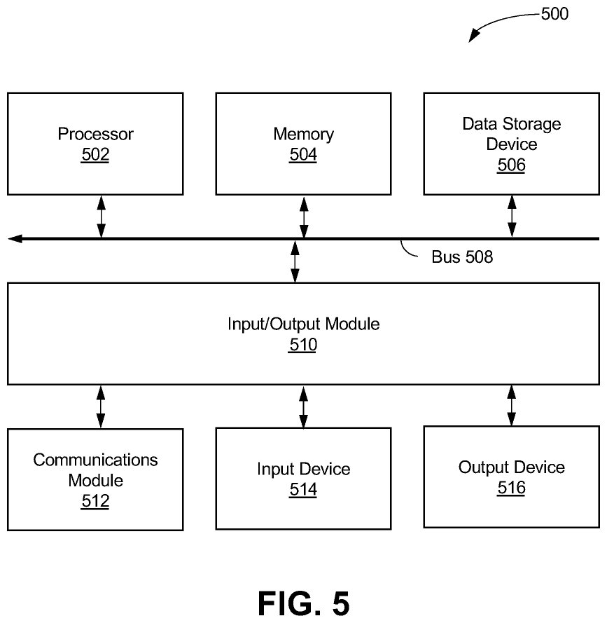

FIG. 5 is a block diagram illustrating an exemplary computer system 500 with which aspects of the subject technology can be implemented. In certain aspects, the computer system 500 may be implemented using hardware or a combination of software and hardware, either in a dedicated server, integrated into another entity, or distributed across multiple entities.

Computer system 500 (e.g., server and/or client) includes a bus 508 or other communication mechanism for communicating information, and a processor 502 coupled with bus 508 for processing information. By way of example, the computer system 500 may be implemented with one or more processors 502. Processor 502 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 500 can include, in addition to hardware, code that creates an execution environment for the computer program in question, e.g., code that constitutes processor firmware, a protocol stack, a database management system, an operating system, or a combination of one or more of them stored in an included memory 504, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. The processor 502 and the memory 504 can be supplemented by, or incorporated in, special purpose logic circuitry.

The instructions may be stored in the memory 504 and implemented in one or more computer program products, i.e., one or more modules of computer program instructions encoded on a computer-readable medium for execution by, or to control the operation of, the computer system 500, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 504 may also be used for storing temporary variable or other intermediate information during execution of instructions to be executed by processor 502.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 500 further includes a data storage device 506 such as a magnetic disk or optical disk, coupled to bus 508 for storing information and instructions. Computer system 500 may be coupled via input/output module 510 to various devices. The input/output module 510 can be any input/output module. Exemplary input/output modules 510 include data ports such as USB ports. The input/output module 510 is configured to connect to a communications module 512. Exemplary communications modules 512 include networking interface cards, such as Ethernet cards and modems. In certain aspects, the input/output module 510 is configured to connect to a plurality of devices, such as an input device 514 and/or an output device 516. Exemplary input devices 514 include a keyboard and a pointing device, e.g., a mouse or a trackball, by which a user can provide input to the computer system 500. Other kinds of input devices 514 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 516 include display devices such as an LCD (liquid crystal display) monitor, for displaying information to the user.

According to one aspect of the present disclosure, the above-described gaming systems can be implemented using a computer system 500 in response to processor 502 executing one or more sequences of one or more instructions contained in memory 504. Such instructions may be read into memory 504 from another machine-readable medium, such as data storage device 506. Execution of the sequences of instructions contained in the main memory 504 causes processor 502 to perform the process steps described herein. One or more processors in a multi-processing arrangement may also be employed to execute the sequences of instructions contained in memory 504. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 500 can include clients and servers. A client and server are generally remote from each other and typically interact through a communication network. The relationship of client and server arises by virtue of computer programs running on the respective computers and having a client-server relationship to each other. Computer system 500 can be, for example, and without limitation, a desktop computer, laptop computer, or tablet computer. Computer system 500 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 502 for execution. Such a medium may take many forms, including, but not limited to, non-volatile media, volatile media, and transmission media. Non-volatile media include, for example, optical or magnetic disks, such as data storage device 506. Volatile media include dynamic memory, such as memory 504. Transmission media include coaxial cables, copper wire, and fiber optics, including the wires that comprise bus 508. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 500 reads game data and provides a game, information may be read from the game data and stored in a memory device, such as the memory 504. Additionally, data from the memory 504 servers accessed via a network the bus 508, or the data storage 506 may be read and loaded into the memory 504. Although data is described as being found in the memory 504, it will be understood that data does not have to be stored in the memory 504 and may be stored in other memory accessible to the processor 502 or distributed among several media, such as the data storage 506.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A universally compatible accessory module, comprising:
a haptics driver;
a light emitting diode (LED) driver;
a battery;
a plurality of LEDs controlled by the LED driver, the plurality of LEDs located along external edges of the module according to a unique geometry; and
at least one mechanical actuator controlled by the haptics driver.

2. The universally compatible accessory module of claim 1, wherein the mechanical actuators are at least one of magnetic and piezo.

3. The universally compatible accessory module of claim 1, wherein the unique geometry comprises spacing the LEDs at a uniform distance apart and then perturbing the spacing by about 1 cm.

4. The universally compatible accessory module of claim 1, wherein the unique geometry is asymmetric.

5. The universally compatible accessory module of claim 1, wherein there are six LEDs.

6. The universally compatible accessory module of claim 1, wherein the module comprises a pair, the pair comprising one module for each hand.

7. The universally compatible accessory module of claim 1, further comprising at least one button, at least one trigger, and/or at least one analogue input.

8. The universally compatible accessory module of claim 1, wherein the module is implemented as an onboard portion and an offboard portion, wherein control electronics are provided on the onboard portion and the LEDs are provided on the offboard portion.

9. The universally compatible accessory module of claim 8, wherein the haptics driver and the light emitting diode (LED) driver are provided on the onboard portion.

10. The universally compatible accessory module of claim 8, wherein the at least one mechanical actuator is provided on the offboard portion.

11. The universally compatible accessory module of claim 8, wherein the onboard portion is linked to the offboard portion by wireless connectors.

12. The universally compatible accessory module of claim 8, wherein the control electronics of the onboard portion are implemented at least in part on a printed circuit board (PCB).

13. The universally compatible accessory module of claim 8, wherein the onboard portion is interchangeably coupled with a variety of different accessories.

14. The universally compatible accessory module of claim 13, wherein a type of the different accessories is identified by a constellation.

15. The universally compatible accessory module of claim 14, wherein left and right side of the same type of separate accessories is identified by the constellation.

16. The universally compatible accessory module of claim 14, wherein orientation of the different accessories is identified by the constellation.

17. The universally compatible accessory module of claim 14, wherein the control electronics adapt for each of the different accessories according to the constellation.

18. The universally compatible accessory module of claim 13, wherein the control electronics adapt for each of the different accessories according to size, shape, haptics, and weight.

19. A universally compatible accessory module, comprising:
a haptics driver;
a light emitting diode (LED) driver;
a battery;
a plurality of LEDs controlled by the LED driver, the plurality of LEDs located along external edges of the module according to a unique geometry; and
at least one mechanical actuator controlled by the haptics driver,
wherein the haptics driver and the LED driver are interchangeably coupled with a variety of different accessories including at least one of sports accessories, inclusive controller, and/or gloves.

20. A universally compatible accessory module, comprising:
a haptics driver;
a light emitting diode (LED) driver;
a battery;
a plurality of LEDs controlled by the LED driver, the plurality of LEDs located along external edges of the module according to a unique geometry;
at least one mechanical actuator controlled by the haptics driver;
an offboard portion having the plurality of LEDs; and
an onboard portion having control electronics including at least the haptics driver and the LED driver,
wherein the onboard portion is interchangeably coupled with a variety of different accessories uniquely identified by a constellation of at least some of the plurality of LEDs,
wherein the different accessories include at least one of sports accessories, inclusive controller, and/or gloves.
